(19) United States
(12) Patent Application Publication
(10) Pub. No.: US 2019/0101512 A1
(43) Pub. Date: Apr. 4, 2019

(54) GUIDED WAVE ACOUSTICAL TRUNNION ROD CRACK DETECTION SYSTEM

(71) Applicant: United States of America as Represented by The Secretary of The Army, Alexandria, VA (US)

(72) Inventors: James A Evans, Tallulah, LA (US); Richard W Haskins, Raymond, MS (US); Jason D Ray, Madison, MS (US)

(21) Appl. No.: 15/815,580

(22) Filed: Nov. 16, 2017

Related U.S. Application Data
(60) Provisional application No. 62/566,409, filed on Sep. 30, 2017.

(51) Int. Cl. G01N 29/46; G01N 29/04; G01N 29/07

(52) U.S. Cl. CPC G01N 29/46; G01N 2291/0234; G01N 29/07; G01N 29/043

(57) ABSTRACT

The present invention is a computer controlled guided acoustic wave testing system, and more specifically an apparatus for detecting cracks in trunnion rods.

### CROSS-REFERENCE TO RELATED APPLICATIONS

This patent application claims the benefit of U.S. Provisional Application No. 62/566,409 filed Sep. 30, 2017. The above application is incorporated by reference herein.

### STATEMENT REGARDING FEDERALLY SPONSORED RESEARCH OR DEVELOPMENT

The invention described herein was made by employees of the United States Government and may be manufactured and used by the Government of the United States of America for governmental purposes without the payment of any royalties thereon or therefore.

### FIELD OF INVENTION

This invention pertains to the field of measurement using acoustic signals, and more specifically to a system for detecting faults in supporting rods enclosed in concrete.

### BACKGROUND OF THE INVENTION

Trunnion rods are support structures used in dams and concrete piers monoliths by to reduce stress on concrete components. Trunnion rods may experience failures are due to stress cracking as the result of corrosion. An excessive number of failures of these rods on a single gate could result in the collapse of the gate and ultimately complete structural failure.

In the past, the primary method used to test the conditions of the rods was to strike the end of the rod with a hammer and listen to the sound of the rod. This was the flexural wave response (guitar string) of the rod. This method, although sometimes effective, was subject to inaccuracy variations in the tautness the presence of materials such as grouting or grease, length of rod, and any curvature or contact of the rods with the enclosing tube and to some extent temperature.

In accordance with the standard design practice, trunnion rods are embedded in the concrete pier and also may be are enclosed in a steel tube with grease or grout as a filler.

Only one end of the rod is normally accessible after installation. Ultrasonic testing methods require an acoustic signal to traverse the entire length of the rod and back. However, the signal is impeded by energy losses at the transducer/rod-end interface, the leakage of the ultrasonic guided wave into the surrounding medium, and the attenuation of the ultrasonic guided wave within the rod.

Additionally, the accessible ends of the rods can be extremely rough and non-uniform due to the various termination methods used during construction to remove excessive length for each rod.

It is a problem known in the art that during ultrasonic or acoustic testing, most of the energy can be lost at the transducer/rod-end interface. There is an unmet need in the art to reduce these losses.

### BRIEF SUMMARY OF THE INVENTION

The invention is trunnion rod testing system that may be used in situ.

A computer processor receives input to generate an activation signal at time T1. A waveform generator is configured to receive the activation signal and to produce and transmit an electric pulse signal. A transducer receives said electric pulse signal from the waveform generator and to produce an acoustic signal. The transducer is operatively coupled to a trunnion rod to form a transducer/rod-end interface.

The transducer transmits said acoustic signal through said trunnion rod at time T2. A reflection of said acoustic signal is received by said transducer at said transducer/rod-end interface. The transducer receives the reflection of the acoustic signal and converts the reflection to an electric analog return signal. An oscilloscope is configured to receive said electric analog return signal from the transducer and transmit it as a digital return signal. A virtual processing component receives said T1 and digital return signal at time T3 and calculates an output travel time (T3−T1). The travel time is interpreted to detect the presence of trunnion rod faults and deformations.

### BRIEF DESCRIPTION OF SEVERAL VIEWS OF THE DRAWING(S)

FIG. 1 illustrates trunnion rod anchors placed inside ducts embedded in concrete (prior art).

FIG. 2 illustrates a block diagram of an acoustical trunnion rod test apparatus.

FIG. 3 includes an exemplary flow chart of a method for acoustically testing a trunnion rod.

FIG. 4 illustrates an exemplary schematic of External Circuitry for preventing overheating of internal circuitry in an acoustical trunnion rod test apparatus.

FIG. 5 illustrates exemplary output from an acoustical trunnion rod test apparatus.

### TERMS OF ART

As used herein, the term “acoustic signal” means a vibration having a measurable frequency, also known as a sound wave.

As used herein, the term “analog return signal” means an electric signal having measurable voltage and emanating from a transducer configured to convert vibrations into electric signals and vice versa.

As used herein, the term “burst and listen” means a mode in which the claimed apparatus is configured to transmit acoustic signals in a single, chosen frequency and receive reflected acoustic signals.

As used herein, the term “distributed computer apparatus” means a computer apparatus having components in one or multiple locations.

As used herein, the term “frequency interval” means the measurement (in Khz) between frequencies of acoustic signals tested during Scan Mode.

As used herein, the term “frequency parameters” means parameter inputs received by a computer processor for selecting frequencies. Frequency parameters include start frequency, frequency interval, stop frequency, number of burst cycles, and number of averages.

As used herein, the term “number of averages” means the number of times each frequency burst will be repeated and the mV reading over time of the digital return signal will be averaged.

As used herein, the term “number of burst cycles” means the number cycles of the chosen frequency.

As used herein, the term “transducer/rod-end interface” means a physical point of contact between the transducer and the trunnion rod, at which an acoustic signal is sent by the transducer along the length of the trunnion rod. The reflected acoustic signal is also received by the transducer at the transducer/rod-end interface.

As used herein, the term “signal averaging function” means the mV reading over time of the digital return signal will be averaged for multiple digital return signals.

As used herein, the term “start frequency” means the lowest frequency of acoustic signals tested during Scan Mode.

As used herein, the term “stop frequency” means the highest frequency of acoustic signals tested during Scan Mode.

As used herein, the term “travel time” means the time required for the computer processor to receive a digital return signal after initiating an activation signal, which the computer calculates as T₃−T₁.

### DETAILED DESCRIPTION OF THE INVENTION

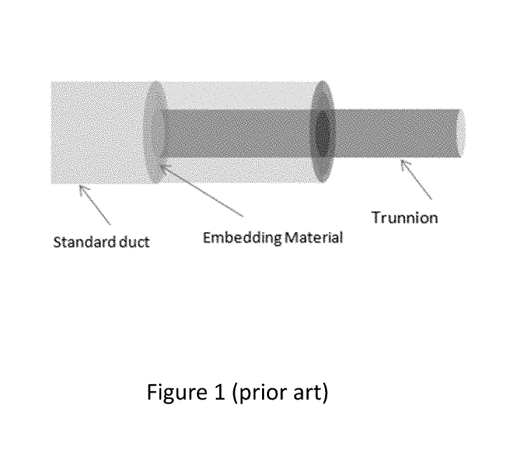

FIG. 1 illustrates trunnion rod anchors placed inside ducts embedded in concrete (prior art). The trunnion rod is placed in a duct that is embedded in a concrete. After the concrete has set and cured, embedding material is added to secure the trunnion. Subsequent to securing, the annular space between the post-tensioning steel and duct is grouted for corrosion protection

In order to test trunnion rods in situ, an ultrasonic guided wave method that can be used to determine the condition of the entire length of a trunnion rod is necessary.

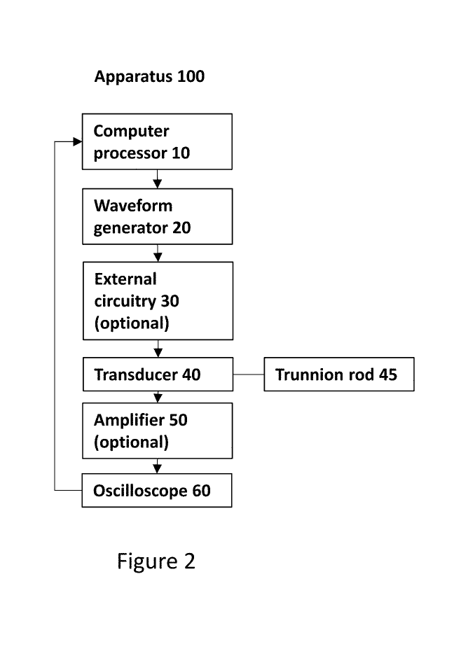

FIG. 2 illustrates a block diagram of acoustical trunnion rod test apparatus 100.

In the exemplary embodiment shown, acoustical trunnion rod test apparatus 100 includes Computer Processor 10, Waveform Generator 20, External Circuitry 30, Transducer 40, Trunnion Rod 45, Variable Gain Amplifier 50, and Oscilloscope 60.

Apparatus 100 tests trunnion rod 45 by vibrating it, creating an acoustic signal that moves along the length of trunnion rod 45. The acoustic signal is reflected back when it reaches the end of the rod. If the path of the vibration (signal) is interrupted by a crack in the rod, it will be reflected back to the transducer before it gets to the end of the rod and the travel time will be shorter. These system components are what generate and store the signals necessary for detecting anomalies within the embedded trunnion rods.

Computer processor 10 receives frequency parameters and generates an activation signal at time T₁.

Computer processor 10 is configured with software, memory, and processing capability to produce three types of outputs. Computer Processor 10 further includes ADC controls and waveform control.

In various exemplary embodiments, Computer Processor 10 may be configured to select a mode for Waveform Generator 20. In various embodiments, the mode may be pre-set or selected from a list that includes: Burst Mode and Scan Mode.

Scan Mode allows the user to test multiple frequencies for the acoustic signal to choose the frequency that yields the highest return signal strength. In Scan Mode, Apparatus 100 sends multiple acoustic signals with a range of frequencies separated by a set interval value and measures the strength of the return signal for each acoustic signal. Scan mode allows the user to set up a range of frequencies to test without having to manually adjust any parameters between tests.

In various embodiments, Computer Processor 10 may be configured to accept frequency parameters. Frequency parameters include Start Frequency, Frequency Interval, Stop Frequency, Number of Burst Cycles, and Number of Averages. Start Frequency is the lowest frequency of acoustic signal tested by Apparatus 100 in Scan Mode. Frequency Interval is the measurement (in Khz) between frequencies of acoustic signals tested by Apparatus 100 in Scan Mode. Stop Frequency is the highest frequency of acoustic signal tested by Apparatus 100. For example, if the Start Frequency is 2 Mhz and the Frequency Interval is 100 Khz, then the next frequency to be tested will be 2.1 Mhz.

Once the range of frequencies is determined, the user is required to enter the Number of Burst Cycles to determine the number of acoustic signal outputs for each frequency tested. For example, if 100 is input, then the burst will start at a 0° phase of the first cycle and end at a 360° phase of the 100th cycle.

Number of Averages is the number of times each frequency burst will be repeated and the mV reading over time of the digital return signal will be averaged. Assuming that the random noise in the system is Gaussian, the more times the signal is averaged with itself the less prevalent the noise is.

In one exemplary embodiment, during Scan Mode, the start frequency was selected to be 2 Mhz; the stop frequency was selected to be 2.5 Mhz, and the interval frequency was selected to be 100 Khz. The number of cycles and the number of averages was 100 each. The transducer used had a stated resonance of 2.25 Mhz.

Based on the results for that exemplary Scan Mode test, the digital return signal with the most energy (e.g. highest Voltage) resulted from an acoustic signal with a frequency around 2 Mhz. Another scan could then be performed for a smaller range of frequencies with a smaller interval. Using this method of tuning, the optimum frequency response for this rod is determined. Once the frequency has been selected, burst mode can be used at this frequency for subsequent testing of rods. The results of these tests can be plotted using commercial plotting software. The “Crack Detection” software has the capability of displaying a single capture. This waveform graphical output comes directly from the DDS without passing through the test network.

Once the frequency scan is complete, frequency analysis of the resultant data is needed in order to determine the optimum digital return signal for the rod. Using the optimum frequency that has been determined, the software is switched to Burst Mode. Burst mode allows only one frequency to be tested. The optimum frequency for the first rod can be applied to the rest of the specimens using burst mode. In Burst Mode, Apparatus 100 sends many acoustic signals with the chosen optimum frequency. In various exemplary embodiments, the user may choose to only operate Scan and Burst Modes.

Waveform generator 20 receives an activation signal from the computer processor and generates an electric pulse signal output. It is capable of operating as a scan or burst and listen output. For the purposes of testing trunnion rods, both of these modes are used. The frequency scan mode will be used to test a range of frequencies to determine the optimum test frequency. Once the testing conditions have been selected, the specific frequency can be used for subsequent tests. In various embodiments, the waveform generator is a commercially available Analog Devices AD5930EBZ.

External Circuitry 30 gates the electric pulse signal, (e.g. limits the amount of time that the signal is on) to prevent overheating the internal circuitry of Apparatus 100. To prevent overheating, the maximum time this electric pulse signal can be on is 250 microseconds. In one embodiment, External Circuitry 30 gates the electric pulse signal by lowering the output impedance to drive a 50 ohm load and to generate the 5V pulse. This means that the RITEC must receive a 5V signal for as long as the input signal is active. As long as the 5V is high the input signal will be amplified.

Transducer 40 is coupled with one end of trunnion rod 45, creating a physical point of contact called the transducer/rod-end interface. Transducer 40 converts an electric pulse signal from waveform generator 20 into an acoustic signal. Transducer 40 transmits the acoustic signal through the transducer/rod-end interface, along the length of trunnion rod 45, starting at time T₂. When the acoustic signal reaches the opposite end of trunnion rod 45 or a crack in trunnion rod 45, it is reflected backward along trunnion rod 45. Transducer 40 receives the reflected acoustic signal at the transducer/rod-end interface and converts it to an electric reflected analog signal.

Variable Gain Amplifier 50 amplifies reflected analog signals and attenuates the acoustic signal on the front end. This device is controlled by a voltage where −600 mV relates to a signal attenuation of −14 dB and 600 mV relates to a signal amplification of 46 dB as shown in FIG. 16. This voltage swing is controlled by Waveform Generator 20.

The upper and lower asymptotes are converted to represent 600 and −600 mV. By adjusting the rise time, the function can have a much sharper level shift.

By adjusting the field labeled “where the curve crosses zero,” the value at which the signal crosses 0 shifts. If the user wishes to have more amplification then a lower value is needed.

In one exemplary embodiment, Variable Gain Amplifier 60 is commercially available Analog Devices AD8336.

Oscilloscope 60 is a computer configured to receive the reflected analog signal from Transducer 40 and convert it to a digital return signal. In one exemplary embodiment, Oscilloscope 60 is a commercially available 2-channel high speed, high resolution oscilloscope capable of sampling at 62.5 Mhz at a 16 bit resolution. In various embodiments, Oscilloscope 60 may be fully programmable with parameters to control how the data is saved, how long it is sampled for, signal thresholds for triggering Oscilloscope 60, and output waveform types and parameters.

Computer processor 10 receives a digital return signal at T₃ and calculates travel time (T₃−T₁) as an output.

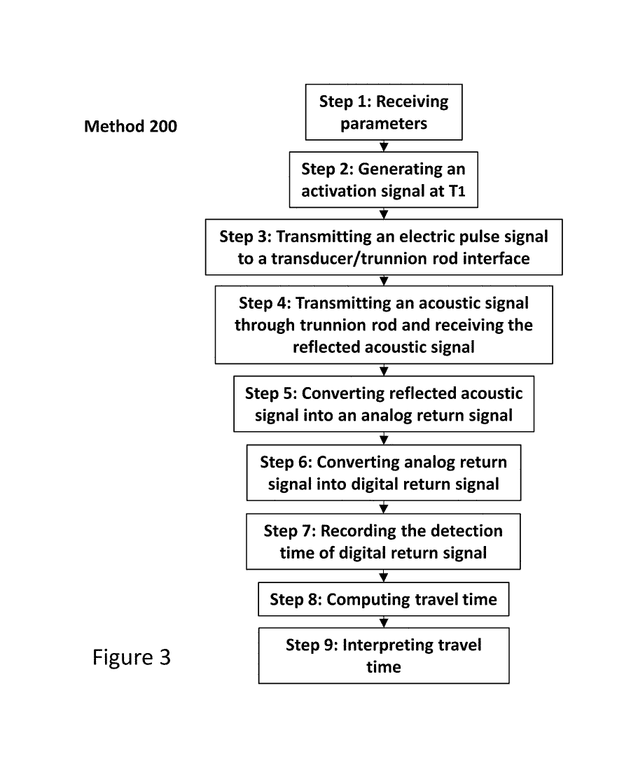

FIG. 3 includes an exemplary flow chart of Method 200 for acoustically testing a trunnion rod.

Step 1 is the step of receiving frequency parameters. Computer Processor 10 is configured to accept frequency parameters

Step 2 is the step of generating an activation signal at time T₁. Computer Processor 10 generates an activation signal at time T₁ and transmits it to Waveform Generator 20.

Step 3 is the step of transmitting an electric pulse signal to a transducer. Waveform Generator 20 transmits an electric pulse signal to Transducer 30.

Step 4 is the step of transmitting an acoustic signal through a trunnion rod and receiving the reflected acoustic signal. The transducer is coupled to a trunnion rod end to create a transducer/rod-end interface. Through this physical connection, the transducer sends the acoustic signal through the trunnion rod at time T₂. The acoustic signal reaches the opposite end of the trunnion rod and is reflected back through the trunnion rod. When the reflected acoustic signal reaches the transducer/rod-end interface, it is received by the transducer.

Step 5 is the step of converting the reflected acoustic signal into an analog return signal. The transducer receives the reflected acoustic signal and converts it into an electric analog return signal.

Step 6 is the step of converting the analog return signal to a digital return signal. The oscilloscope receives the analog return signal from the transducer and converts it into a digital return signal and transmits it to the computer processor.

Step 7 is the step of recording the detection time of the digital return signal. The computer processor detects the digital return signal from the oscilloscope and records the detection time T₃.

Step 8 is the step of computing travel time of the signal. The computer processor computes the signal travel time as T₃−T₁.

Step 9 is the step of interpreting the travel time of signal. The computer processor plots the Voltage of digital return signals from the oscilloscope over time. A typical scan of a trunnion rod has a first return (the “y” ordinate, e.g. the y-value, which is the measured millivolt value) representing the transmission of the acoustic signal down the trunnion rod while the second return represents the reflection of the acoustic signal by the backend (e.g. opposite end) of the rod (the fixed end). A secondary reflection (showing a Voltage significantly smaller than the backend reflection) is also shown as the sound makes a second return down the trunnion rod. A user can recognize a fault or crack in the rod, which is represented by detection of a secondary reflection before the backend reflection.

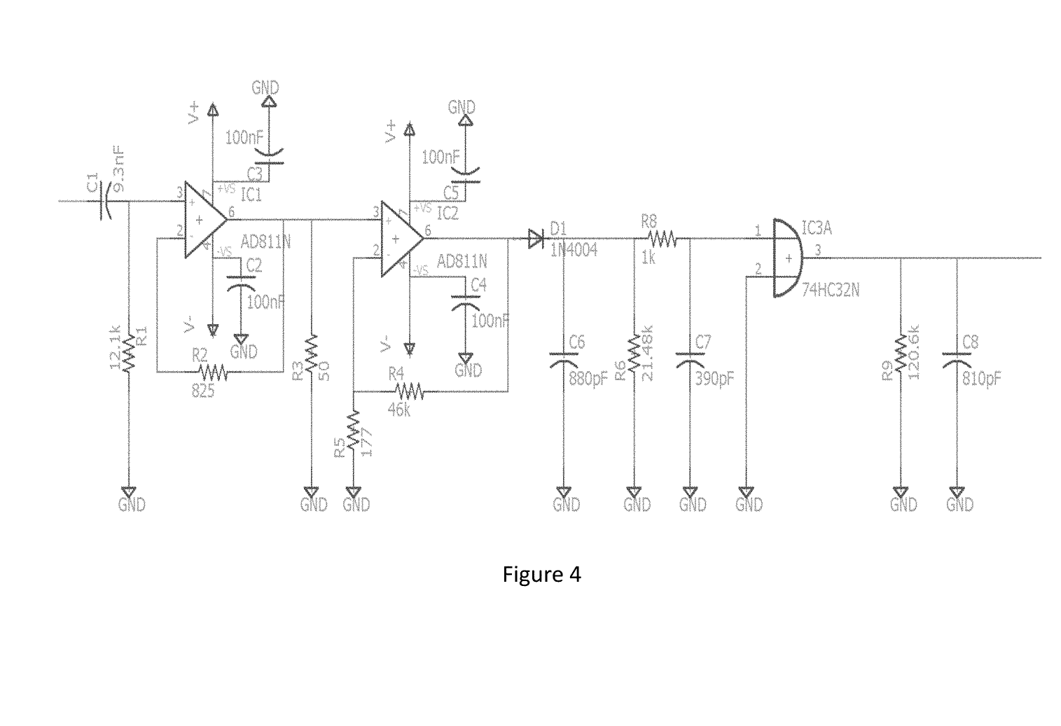

FIG. 4 illustrates an exemplary schematic of External Circuitry 50 for preventing overheating of internal circuitry in acoustical trunnion rod test apparatus 100.

FIG. 4 illustrates External Circuitry 30 that prevents internal circuitry from overheating by controlling the electric pulse signal. In the exemplary embodiment shown, External Circuitry 30 prevents overheating by limiting the transmission time of a 5V electric pulse signal to 250 microseconds. In the exemplary embodiment shown, External Circuitry 30 limits the transmission time by lowering the output impedance to drive a 50 ohm load and to generate the 5V pulse.

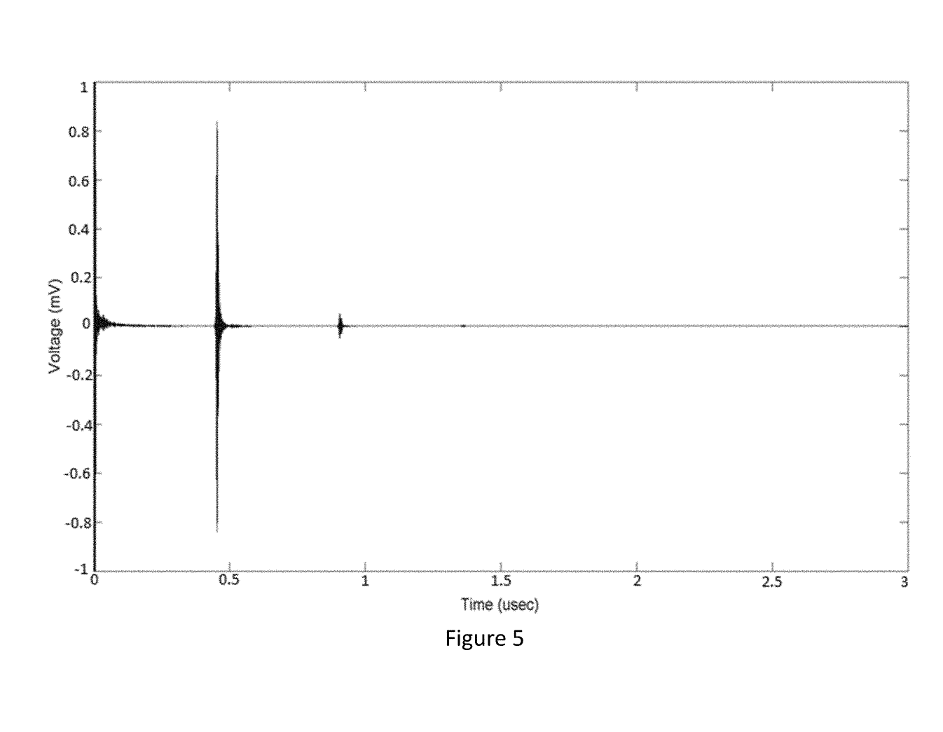

FIG. 5 illustrates exemplary output from acoustical trunnion rod test apparatus 100.

A typical scan of a trunnion rod has a first return (the “y” ordinate, e.g. the y-value, which is the measured mV value) representing the transmission of the acoustic signal down the trunnion rod while the second return represents the reflection of the acoustic signal by the backend (e.g. opposite end) of the rod (the fixed end). A secondary reflection (showing a Voltage significantly smaller than the backend reflection) is also shown as the sound makes a second return down the trunnion rod. A fault or crack in the rod would show up as a secondary reflection before the backend reflection.

It will be understood that many additional changes in the details, materials, procedures and arrangement of parts, which have been herein described and illustrated to explain the nature of the invention, may be made by those skilled in the art within the principle and scope of the invention as expressed in the appended claims.

It should be further understood that the drawings are not necessarily to scale; instead, emphasis has been placed upon illustrating the principles of the invention.

What is claimed is:

1. A trunnion rod testing distributed computer apparatus with memory and processing components comprised of:
a computer processor that receives input to generate an activation signal at time T₁;
a waveform generator configured to receive said activation signal and to produce and transmit an electric pulse signal;
a transducer configured to receive said electric pulse signal from said waveform generator and to produce an acoustic signal;
wherein said transducer is operatively coupled to a trunnion rod to form a transducer/rod-end interface;
wherein said transducer/rod-end interface is a physical point of the contact with said trunnion rod from which said transducer transmits said acoustic signal through said trunnion rod at time T₂;
wherein a reflection of said acoustic signal is received by said transducer at said transducer/rod-end interface; and
wherein said transducer receives said reflection of said acoustic signal and converts said reflection to an electric analog return signal; and
an oscilloscope configured to receive said electric analog return signal from said transducer and transmit it as a digital return signal; and
wherein said computer processor is a virtual processing component that receives said T₁ and digital return signal at time T₃ and calculates an output travel time (T₃−T₁).

2. The distributed computer apparatus of claim 1, wherein said virtual processor is further configured to iteratively calculate travel time for each of said acoustic signals.

3. The distributed computer apparatus of claim 1, which is further configured to perform an averaging function to produce a plot of averaged voltage over time of a plurality of said digital return signal.

4. The distributed computer apparatus of claim 1, wherein said waveform generator is a commercially available Analog Devices AD5930EBZ.

5. The distributed computer apparatus of claim 1, wherein said transducer has a stated resonance of 2.25 Mhz.

6. The distributed computer apparatus of claim 1, wherein said oscilloscope is a commercially available 2-channel high speed, high resolution oscilloscope capable of sampling at 62.5 Mhz at a 16 bit resolution.

7. The distributed computer apparatus of claim 1, wherein said oscilloscope may be fully programmable with parameters to control options from a list consisting of the following: how the data is saved, how long said oscilloscope samples, signal thresholds for triggering said oscilloscope, and output waveform types.

8. The distributed computer apparatus of claim 1, which further includes a variable gain amplifier which amplifies said reflected acoustic signal.

9. The apparatus of claim 1, which further includes a display component that updates and plots data

10. The apparatus of claim 1, which further includes external circuitry that drives a 50 ohm load and generates a 5V pulse.

11. A method for testing for cracks in a trunnion rod comprised of the steps of:
receiving frequency parameters;
generating an activation signal at time T₁;
transmitting an electric pulse signal to a transducer/rod-end interface;
transmitting an acoustic signal along said trunnion rod;
receiving a reflected acoustic signal;
converting said reflected acoustic signal to an analog signal;
converting said analog signal to a digital return signal;
recording a detection time of said digital return signal;
computing travel time; and
interpreting travel time.

12. The method of claim 11, which further includes the step of amplifying said reflected acoustic signal.

13. The method of claim 11, which further includes the step of performing a signal averaging function.

14. The method of claim 11, which further includes the step of selecting a mode from a group consisting of scan and burst.

15. The method of claim 11, which further includes the step of receiving said digital return signal at T₃ and calculating said travel time (T₃−T₁).

16. The method of claim 11, which further includes the step of updating frequency parameters.

17. The method of claim 16, wherein the step of updating frequency parameters further includes the step of inputting a start frequency.

18. The method of claim 16, wherein the step of updating frequency parameters further includes the step of inputting a frequency interval.

19. The method of claim 16, wherein the step of updating frequency parameters further includes the step of inputting a stop frequency.

20. The method of claim 16, wherein the step of updating frequency parameters further includes the step of inputting a number of burst cycles.
